(19) United States
(12) Patent Application Publication
(10) Pub. No.: US 2016/0296814 A1
(43) Pub. Date: Oct. 13, 2016

(54) BALL SERVING MECHANISM FOR PET

(71) Applicant: Asder Electronic Co., LTD., Taipei City (TW)

(72) Inventors: Ching-Kuo Hsu, Taipei City (TW); Chih-Hong Wang, Taipei City (TW); I-Lun Kuo, Taipei City (TW)

(21) Appl. No.: 15/096,248

(22) Filed: Apr. 11, 2016

(30) Foreign Application Priority Data
Apr. 10, 2015 (TW) 104205379

(51) Int. Cl. A63B 65/12; A01K 15/02

(52) U.S. Cl. CPC A63B 65/12; A01K 15/025; A01K 15/027

(57) ABSTRACT

A ball serving apparatus for pet including a housing, a rail assembly, and a launch module is provided. The housing has an inlet and an outlet. The rail assembly assembled in the housing is connected to the inlet. The launch module is assembled in the housing and connected between the rail assembly and the outlet. A ball is suitable for being put into the inlet to move in the rail assembly by gravity continuously. After moving to the launch module, the ball is launched out of the housing through the outlet by being driven by the launch module.

### CROSS-REFERENCE TO RELATED APPLICATION

This application claims the priority benefit of Taiwan application serial no. 104205379, filed on Apr. 10, 2015. The entirety of the above-mentioned patent application is hereby incorporated by reference herein and made a part of this specification.

### BACKGROUND OF THE INVENTION

1. Field of the Invention

The invention is related to a ball serving mechanism, and more particularly to a ball serving mechanism for pet.

2. Description of Related Art

The main purposes of pet toys are to enhance the relationship between pet owners and their pets as well as increase pets' trust in their owners through the interaction between them, while keeping the pets physical and mentally energetic though exercise without causing too much physical burden to the owner. Generally speaking, pets may be attracted to special scent, sound effect with special frequency or fast moving object. Accordingly, in consideration of all the above factors, pet toys are designed according to pets' preference mentioned above.

For cats and dogs, “object retrieving” is a preferable way of training. The purpose of training can be attained through interaction of tossing, catching and retrieving an object, e.g. a ball. However, sometimes the pet owner may not be in the mood or have the time to carry out the above activity with the pet. Therefore, it is an issue for persons in the field to think about how to design a device for pet which serves to train the pet to “retrieve objects” in absence of the pet owner.

### SUMMARY OF THE INVENTION

The invention provides a ball serving mechanism for pet, which is designed with a rail in cooperation with an automatic launch module to launch a ball for the pet to catch, and can repeat the above process after the pet puts the ball back to the mechanism.

The ball serving mechanism for pet of the invention includes a housing, a rail assembly and a launch module. The housing has an inlet and an outlet. The rail assembly is configured within the housing and connected to the inlet. The launch module is configured within the housing and connected between the rail assembly and the outlet. The ball is suitable for entering the rail assembly via the inlet and smoothly moves in the rail assembly via gravity to the launch module; thereafter, the ball is launched out of the housing via the outlet by being driven by the launch module.

In an embodiment of the invention, the rail assembly is in a spiral shape.

In an embodiment of the invention, the rail assembly has a first rail and a second rail. The first rail is connected to the inlet; the second rail is connected between the first rail and the launch module. The first rail surrounds an axis, and the axis is parallel with a normal of a plane on which the housing is placed.

In an embodiment of the invention, the housing includes a base. The rail assembly includes a base plate, a frame, and a cover assembled on the base. The frame and the base plate are jointed together, and the base plate as well as a portion of the frame are configured to form the second rail. The cover covers the base plate and the frame, and another portion of the frame and the cover are configured to form the first rail.

In an embodiment of the invention, the housing includes a base, and the rail assembly includes a base plate, a frame and a barrier assembled on the base. The frame is jointed with the base plate, and the base plate as well as a portion of the frame are configured to form the second rail. The barrier is formed on an external edge of the frame. Another portion of the frame and the barrier are configured to form the first rail.

In an embodiment of the invention, the housing further includes a base, a first housing and a second housing. The first housing and the second housing are bilaterally symmetrically assembled on the base.

In an embodiment of the invention, the launch module includes a launch tube and a pair of ball serving rollers. The launch tube is configured within the housing and connected between the rail assembly and the outlet. The ball serving rollers are configured on the base at opposite sides of the launch tube. A partial portion of each ball serving roller passes through a tube wall of the launch tube and protrudes in the launch tube.

In an embodiment of the invention, the ball serving mechanism for pet further includes at least a motor, a controlling unit and a sensor unit. The motor is configured within the housing and connected to the ball serving rollers. The motor drives the ball serving rollers to rotate. The controlling unit is configured within the housing and electrically connected to the motor. The sensor unit is configured on the inlet and electrically connected to the controlling unit. When the ball enters the rail assembly via the inlet, the sensor unit senses the ball and transmits a signal to the controlling unit such that the controlling unit activates the motor to drive the ball serving rollers.

In an embodiment of the invention, the ball moves to the ball serving rollers from the inlet within a first time period; the motor drives the ball serving rollers to rotate from a still status to a launching speed within a second time period, wherein the second time period is less than or equal to the first time period.

In an embodiment of the invention, at least one of the first rail and the second rail is provided with at least a protrusion configured on a surface thereof to reduce the moving speed of the ball in the rail assembly.

Based on the above, with cooperation of the rail assembly and the launch module of the ball serving mechanism for pet, the ball enters the housing via the inlet and moves smoothly along the rail assembly to the launch module. Thereafter, the ball is launched out of the housing via the outlet by being driven by the launch module, whereby providing the training process of training the pet to “catch object”. Also, after the pet puts the ball back to the ball serving mechanism for pet, the same training process can be repeated. Accordingly, after the pet is familiar with the repeated “object catching” process, there is no need for the pet owner to stay with the pet and the ball serving mechanism, whereby effectively saving the owner's time and energy.

In order to make the aforementioned features and advantages of the invention more comprehensible, embodiments accompanying figures are described in detail below.

### BRIEF DESCRIPTION OF THE DRAWINGS

FIG. 1 is a schematic perspective view illustrating a ball serving mechanism for pet according to an embodiment of the invention.

FIG. 2 is a top view illustrating a ball serving mechanism for pet according to FIG. 1.

FIGS. 3-4 are exploded views illustrating a ball serving mechanism for pet of the embodiment from different viewing angles.

FIGS. 5-6 are schematic views illustrating a frame and a base plate from different viewing angles.

FIG. 7 is a schematic view illustrating electrical connection of components in the embodiment.

FIG. 8 is a side view illustrating the ball serving mechanism for pet according to FIG. 1.

FIG. 9 is a schematic view illustrating partial components of a ball serving mechanism for pet according to another embodiment of the invention.

FIG. 10 is a partial schematic view illustrating a rail assembly according to another embodiment of the invention.

FIG. 11 is a schematic view illustrating partial components of a ball serving mechanism for pet according to another embodiment of the invention.

FIG. 12 is a partial sectional view illustrating a launch module according to FIG. 11.

FIG. 13 is a schematic perspective view illustrating a ball serving mechanism for pet according to another embodiment of the invention.

FIGS. 14 and 15 are exploded views illustrating the ball serving mechanism for pet in FIG. 13.

### DESCRIPTION OF EMBODIMENTS

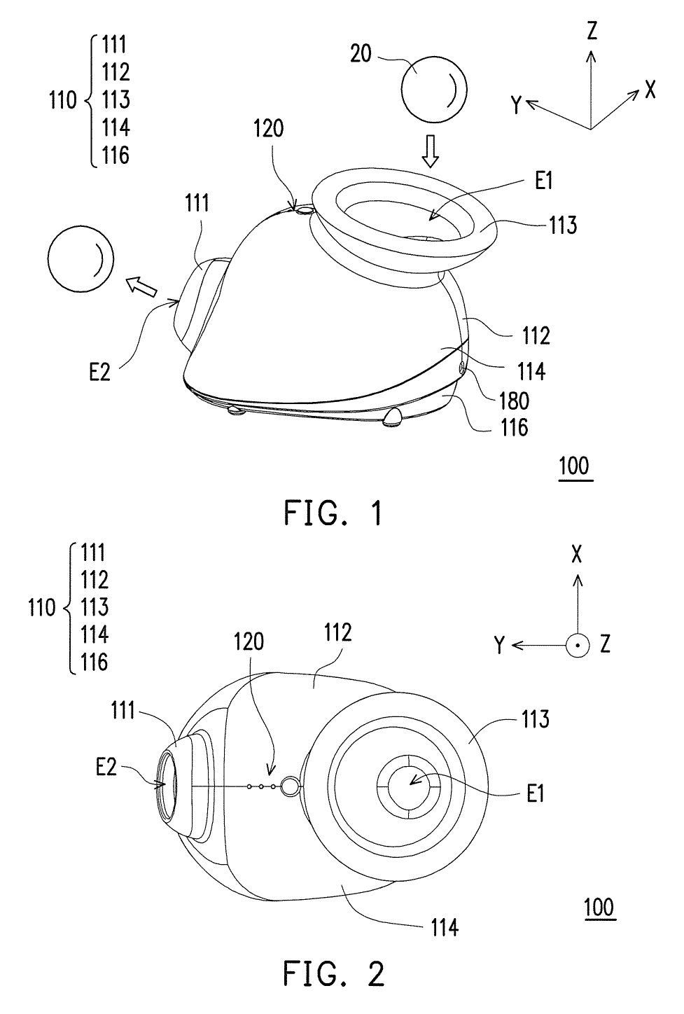

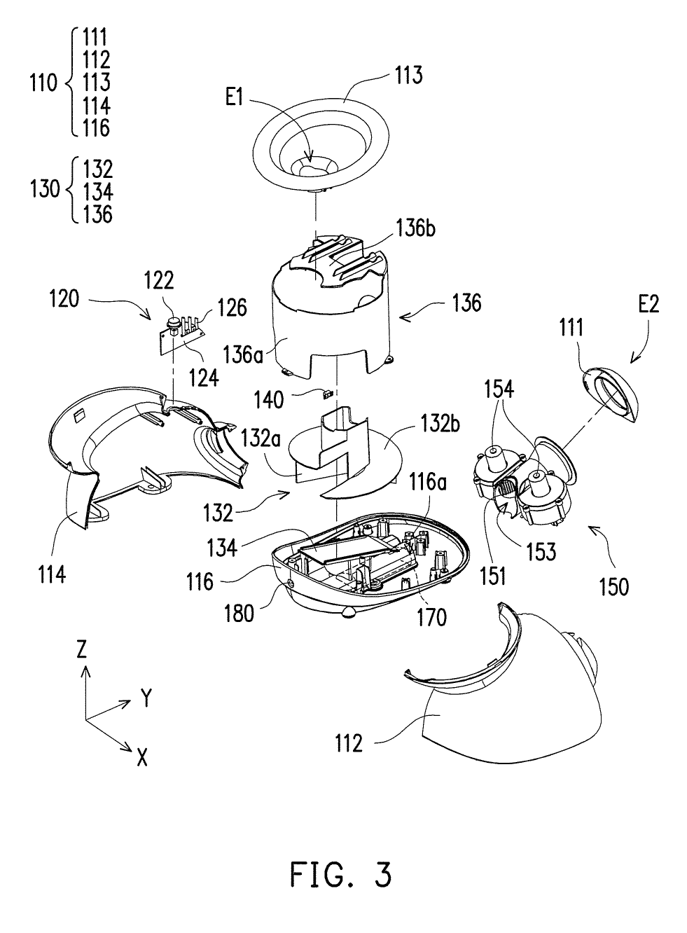

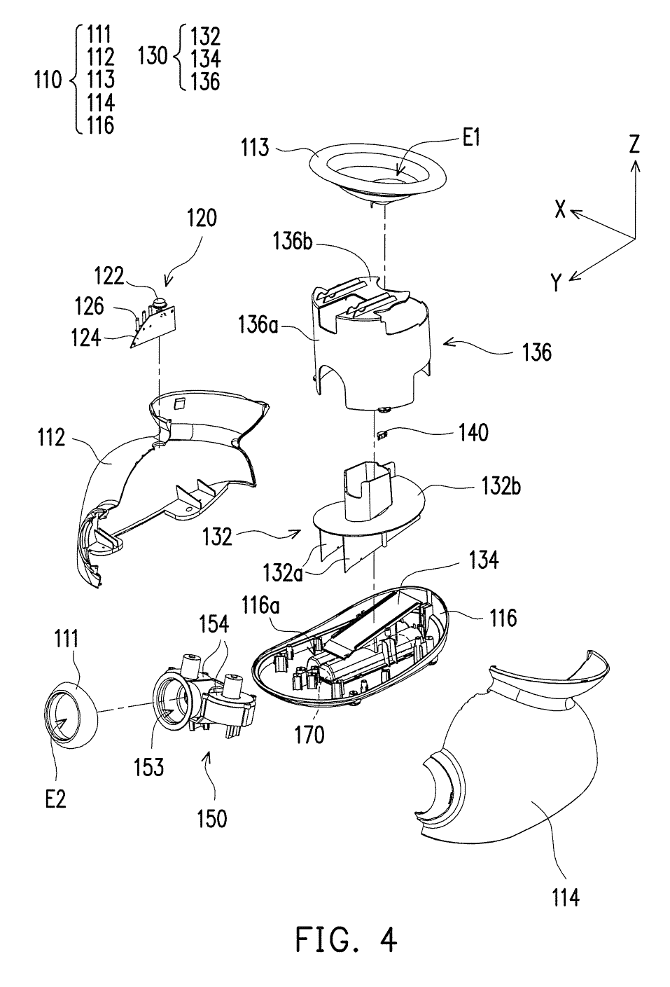

FIG. 1 is a schematic perspective view illustrating a ball serving mechanism for pet according to an embodiment of the invention. FIG. 2 is a top view illustrating a ball serving mechanism for pet according to FIG. 1. FIGS. 3-4 are exploded views illustrating a ball serving mechanism for pet of the embodiment from different viewing angles. Please refer to FIGS. 1-4. In the embodiment, a ball serving mechanism for pet 100 includes a housing 110, a rail assembly 130 and a launch module 150, wherein the rail assembly 130 and the launch module 150 are assembled within the housing 110. The housing 110 has an inlet E1 at a top portion and an outlet E2 at a front side portion; the rail assembly 130 inside the housing 110 is connected to the inlet E1, and the launch module 150 is disposed between the rail assembly 130 and the outlet E2. A ball 20 is suitable for entering the housing 110 of the ball serving mechanism for pet 100 via the inlet E1 and moves within the rail assembly 130 via gravity and further moves to the launch module 150; thereafter, the ball is launched out of the housing 110 of the ball serving mechanism for pet 100 via the outlet E2 by being driven by the launch module 150.

Accordingly, the ball serving mechanism for pet 100 can carry out the training process of training the pet to “catch object” in absence of the pet owner. In other words, the process of training the pet to “catch object” can be carried out by simply placing the ball serving mechanism for pet 100 on the ground or any place where the pet can move around. Apart from that, after catching the object, the pet is trained to put the “object”, e.g. the ball 20 described in the embodiment, into the ball serving mechanism for pet 100 via the inlet E1 so as to continuously repeat the training process of “catching object”. Meanwhile, there is no need for the pet owner to stay with the ball serving mechanism for pet 100, whereby saving the owner's energy and time.

It should be pointed out that the ball 20 provides no limitation to the “object to be caught” of the invention. In other words, anything such as food, disk, toy and so on that can be put into the rail assembly 130 and moves within the rail assembly 130 via gravity, and can be launched out of the outlet E2 after arriving and being driven by the launch module 150 may be the object to be operated by the ball serving mechanism for pet 100 of the invention, and the invention provides no limitation to the quantity thereof.

In the embodiment, the housing 110 consists of a base 116, a first housing 112, a second housing 114, an upper cover 113 and a front cover 111, wherein the first housing 112 and the second housing 114 are bilaterally symmetrically assembled on the base 116. In the meantime, a controlling and displaying assembly 120 is embedded therein. As shown by FIGS. 3-4, the controlling and displaying assembly 120 includes a circuit board 124 and a button 122 as well as three display lamp signs 126 configured thereon. After the first housing 112 and the second housing 114 are assembled, the button 122 and the three display lamp signs 126 are exposed from the housing 110 (as shown by FIGS. 1-2) for the user's operation and identification. In FIGS. 3-4, to keep the drawings clear and easy to read, the controlling and displaying assembly 120 is illustrated to be adjacent to the first housing 112 or the second housing 114. The function of the controlling and displaying assembly 120 is described in details below.

Next, after the first housing 112 and the second housing 114 are assembled together with the rail assembly 130 and the launch module 150 accommodated therein, the upper cover 113 having the inlet E1 is further assembled on the first housing 112 and the second housing 114 to complete the top portion of the housing 110. The front cover 111 having the outlet E2 is assembled on the first housing 112 and the second housing 114 to complete the structure of the front side portion of the housing 110.

Furthermore, the ball serving mechanism for pet 100 further includes a power jack 180 and a battery 170, wherein the power jack 180 is disposed on the base 116 to be opposite to the outlet E2, serving to receive alternate current power (not shown). The battery 170 is disposed in a battery groove 116a (being limited by the viewing angle of the drawing, only a rear surface thereof is illustrated; nevertheless, the feature thereof can be unambiguously identified based on the profile shown in the drawing and related descriptions) of a bottom portion of the base 116. Accordingly, no matter where the ball serving mechanism for pet 100 is located, it can have power supply to function normally via the power jack 180 or the battery 170 without being restricted by the environment. In addition, the battery 170 disposed in the bottom portion of the base 116 not only supplies power but also increases structural stability of the ball serving mechanism for pet 100 with its weight, lowering center of gravity of the structure of the ball serving mechanism for pet 100 so it does not collapse when being accidentally hit by the pet or the pet owner.

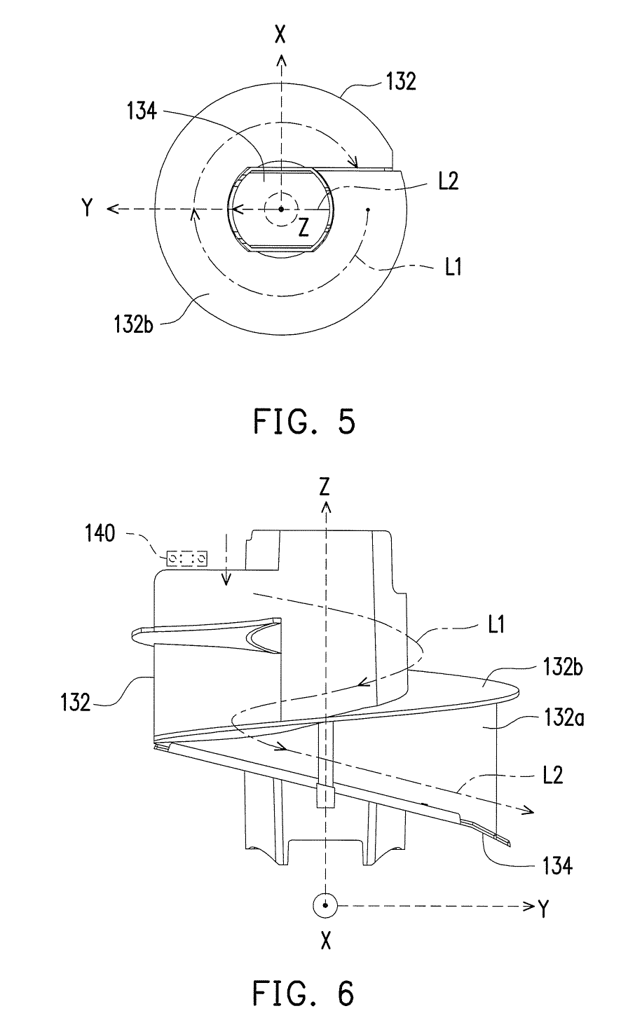

Please further refer to FIGS. 3-4. The rail assembly 130 includes a base plate 134, a frame 132 and a cover 136, wherein the base plate 134 is assembled on the base 116 and configured above a battery groove 116a. The frame 132 is assembled on the base 116 and overlaps on the base plate 134. The cover 136 is assembled on the base 116 and covers the frame 132 as well as the base plate 134 all over. FIGS. 5-6 are schematic views illustrating the frame and the base plate from different viewing angles. Please refer to FIGS. 3-6. In the meantime, a Cartesian coordinate system is provided to clearly describe related components. Also, in FIGS. 5-6, a first rail L1 and a second rail L2 that are illustrated with trace lines are described with reference of Cartesian coordinate system for better clarity, wherein the ball serving mechanism for pet 100 in the embodiment is arranged in the manner that the base 116 of the housing 110 is placed on an X-Y plane.

In the embodiment, the base plate 134 is configured in the rear surface of the battery groove 116a of the base 116 in a tilting status along Y-axis; that is, the base plate 134 tilts forward in a positive Y-axis direction such that displacement is generated between opposite ends along Z-axis, which helps the ball 20 to move toward the launch module 150 due to gravity. The frame 132 is assembled on the base plate 134, which enables a side plate 132a of the frame 132 to be jointed with the base plate 134 to form the second rail L2. Additionally, the frame 132 further has a spiral plate 132b which surrounds the Z-axis and generates displacement along the Z-axis to be in a spiral shape. After the cover 136 is assembled on the base 116 to cover the frame 132 and the base plate 134 all over, a column-shaped external wall 136a of the cover 136 together with the spiral plate 132b of the frame 132 form the first rail L1. In other words, the ball 20 moves along the profile of the spiral plate 132b due to restriction of the external wall 136a and moves smoothly to the second rail L2. Moreover, a top wall 136b of the cover 136 covers the top portion of a portion of the first rail L1. It should be pointed out that, to take out the ball 20 which is already put into the ball serving mechanism for pet 100 under the condition that the launch module 150 is not activated, the ball serving mechanism for pet 100 may be placed upside down so that the ball 20 leans against the top wall 136b and moves out of the ball serving mechanism for 100 via the inlet E1.

That is to say, different portions of the frame 132 together with the cover 136 and the base plate 134 form the first rail L1 and the second rail L2 respectively, wherein an orthogonal projection of the second rail L2 on the X-Y plane passes through the Z-axis, and an orthogonal projection of the inlet E1 on the X-Y plane is also within the orthogonal projection range of the second rail L2 on the X-Y plane. The orthogonal projection of the inlet E1 on the X-Y plane is not on the Z-axis.

Furthermore, the displacement is generated along the Z-axis when the spiral plate 132b of the frame 132 rotates relative to the Z-axis, which represents that the first rail L1 also substantially tilts along the Y-axis to a degree equivalent to the base plate 134 (as shown by FIG. 6, a tilting angle of the first rail L1 on the Y-axis relative to the Z-axis is substantially equivalent to a tilting angle of the second rail L2 relative to the Z-axis). Therefore, similar to the base plate 134, displacement is generated between opposite ends of the spiral plate 132 along the Z-axis, which helps the ball 20 to move smoothly between the first rail L1 and the second rail L2 in the rail assembly 130 and further move to the launch module 150.

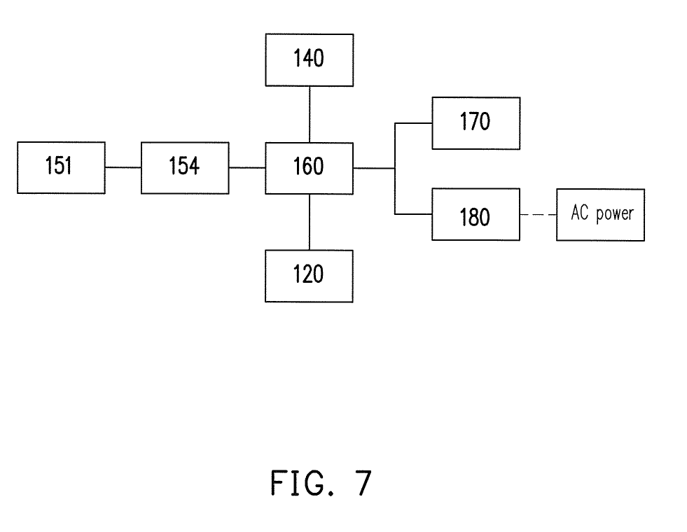

FIG. 7 is a schematic view illustrating electrical connection of components in the embodiment. Please refer to FIGS. 3-4 and 7. In the embodiment, the ball serving mechanism for pet 100 further includes a pair of motors 154, a controlling unit 160 and a sensor unit 140 disposed within the housing (wherein the controlling unit 160 is, for example, an electronic device (e.g. processor) disposed on the circuit board 124, which can be acquired based on known techniques; therefore, no further descriptions are incorporated herein. Only the electrical relation between the controlling unit and other components is described), wherein the motor 154, the sensor unit 140, the controlling and displaying assembly 120, the battery 170 and the alternate current power (via the power jack 180) can be electrically connected to the controlling unit 160, whereby achieving the purpose of turning on/off or adjusting the motor 154 via the controlling unit 160. It should be pointed out that the above descriptions sufficiently describe the electrical connection relation between related components, and the structure can certainly achieve the relation based on known techniques; therefore, no further descriptions are incorporated herein.

Furthermore, the launch module 150 includes a launch tube 153 and a pair of ball serving rollers 151, wherein the launch tube 153 is assembled on the base 116 and connected to the second rail L2. That is, the base plate 134 docks with the launch tube 153 so that the ball 20 can move from the base plate 134 into the launch tube 153. The ball serving rollers 151 are configured on the base 116 and located at opposite sides of the launch tube 153 different from the second rail L2 and the outlet E2 (along the X-axis). A portion of each ball serving rollers 151 passes through the tube wall of the launch tube 153 and protrudes in the launch tube 153.

The motor 154 is correspondingly connected to the ball serving rollers 151 so as to control the ball serving rollers 151 to stop or rotate. The sensor unit 140 (see FIG. 6) is configured on the inlet E1 and electrically connected to the controlling unit 160. When the ball 20 enters the rail assembly 130 via the inlet E1, the sensor unit 140 senses the ball 20 passing through and transmits a signal to the controlling unit 160 such that the controlling unit 160 activates the motor 154 to drive the ball serving rollers 151 to rotate. It should be pointed out that the invention provides no limitation to the quantity of the motor 154. In another embodiment that is not shown, it is possible that one motor can drive two ball serving rollers 151 at the same time.

For example, the pet owner may press the button 122 to adjust the rotating speed of the ball serving rollers 151 driven by the motor 154 and control the speed of the ball 20 to be launched out of the ball serving mechanism for pet 100 by referring to the rotating speed currently shown by the display lamp sign 126.

It should be noted that the ball 20 moves from the inlet E1 through the first rail L1 and the second rail L2 to the launch tube 153 within the first time period via gravity to be driven by the ball serving rollers 151. As for the ball serving rollers 151, when the sensor unit 140 senses the ball 20 passing through as described above, the ball serving rollers 151 are correspondingly driven by the motor 154 to start rotating from the still status, and the motor 154 makes the ball serving rollers 151 begin rotating to the launch speed from the still status within the second time period. The second time period is less than or equivalent to the first time period. In other words, in the embodiment, the design of the rail assembly 130 makes it possible to effectively control the schedule of the first rail L1 and the second rail L1 such that the ball serving rollers 151 can rotate to the required launch speed from the still status when the ball 20 moves in the rail assembly 130 within the first time period.

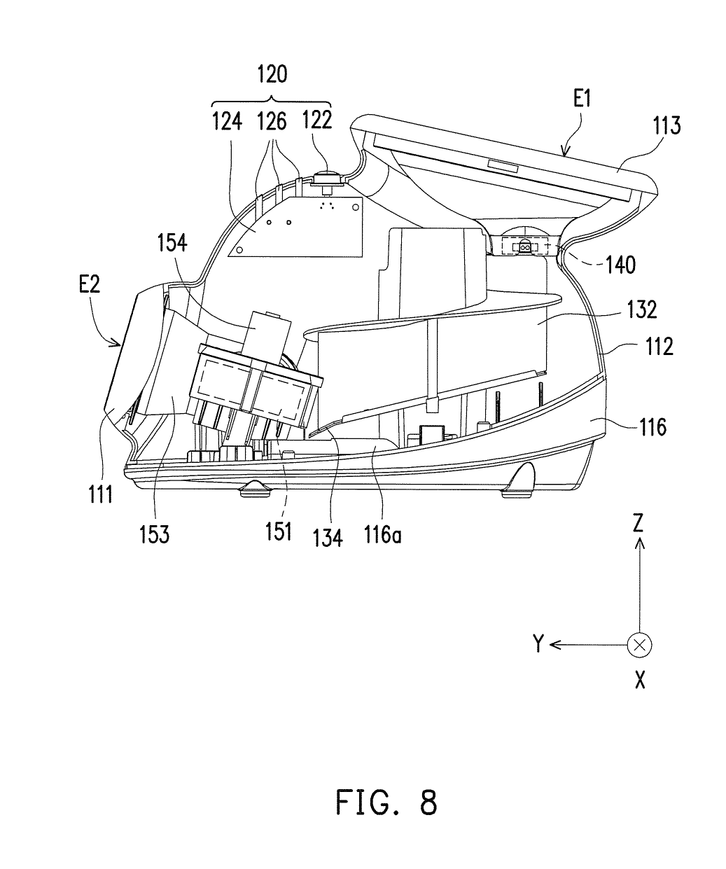

FIG. 8 is a side view illustrating the ball serving mechanism for pet according to FIG. 1, in which a partial portion of the housing 110 and the cover 136 are omitted so the corresponding relation between the frame 132 of the rail assembly 130, the base plate 134, the launch module 150 and the housing 110 can be easily identified. Please refer to FIGS. 3-4 and 8. As shown by FIG. 8, within the limited space inside the housing 110, the issue is how to make the motor 154 to drive the ball serving rollers 151 to rotate to the launch speed within the first time period that the ball 20 enters from the inlet E1 and moves to the launch module 150. To deal with the issue, the invention provides the rail assembly 130 as described above. That is, with the first rail L1 that surrounds the Z-axis, the time that the ball 20 remains in the housing 110 can be extended (i.e. the first time period described above). Accordingly, during the process in which the ball 20 moves, the motor 154 can drive the ball serving rollers 151 to rotate to the launch speed. Therefore, the first rail L1 of the invention is a trace profile formed in a surrounding manner inside the housing 110, and the first rail L1 is closely adjacent to the inner wall of the housing 110 to form a close packed structure, whereby improving the moving process of the ball 20 within the housing 110.

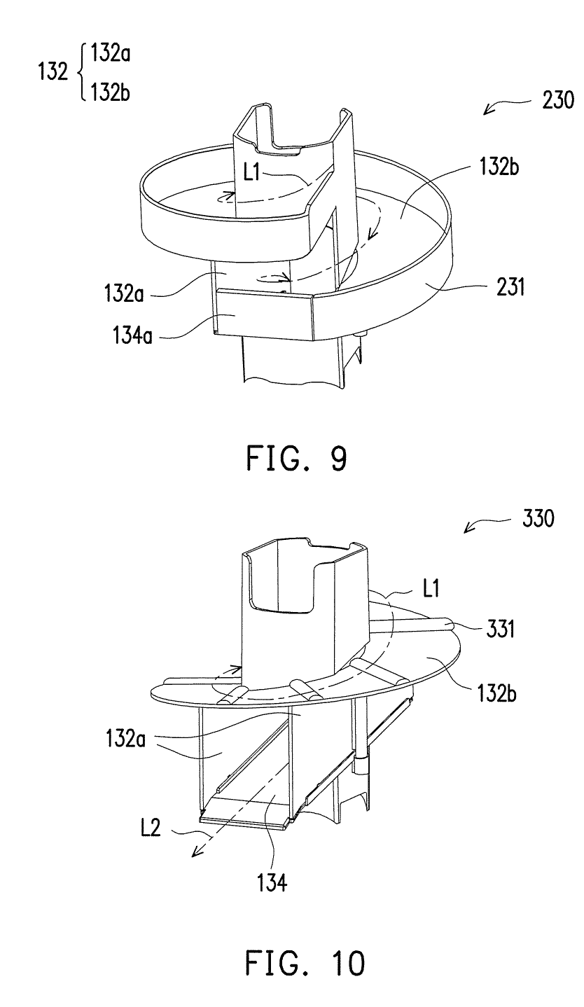

FIG. 9 is a schematic view illustrating partial components of a ball serving mechanism for according to another embodiment of the invention, which shows structural features of a rail assembly 230. Apart from the previously described base plate 134 (not shown due to limitation of the viewing angle), the spiral plate 132b and side plate 132a of the frame 132, the difference lies in that the rail assembly 230 of the embodiment further includes a barrier 231 formed on an external edge of the spiral plate 132b of the frame 132. In the meantime, the barrier 231 and the spiral plate 132b are configured to form the first rail L1 of the embodiment. In other words, there is no need for the rail assembly 230 in the embodiment to have the external wall 136a of the cover 136 described above. Instead, the barrier 231 provides an effect that prevents the ball 20 (shown by FIG. 1) from falling out of the first rail L1 and guides the ball 20 during the moving process. The invention provides no limitation to the appearance and size of the barrier 231, which may be designed corresponding to the object (i.e. the ball 20 in the above embodiment) that moves in the first rail L1. In addition, the side edge of the base plate also forms a barrier 134a, such that the barriers 231 and 134a may be docked with each other after the frame 132 is combined with the base plate 134. Accordingly, it can be ensured that the ball 20 does not fall out of the rail assembly 230 when passing through the position where the first rail L1 and the second rail L2 are connected.

FIG. 10 is a partial schematic view illustrating a rail assembly according to another embodiment of the invention. Different from the above embodiment, the spiral plate 132b configured for forming the first rail L1 of the embodiment is further provided with a plurality of protrusions 331 which are, for example, an arc-shaped column-like structure arranged laterally for effectively reducing the moving speed of the ball 20 (shown by FIG. 1) when moving in the rail assembly 330 and also increasing the time that the ball 20 remains in the rail assembly 330. However, the invention provides no limitation to the appearance and the size of the protrusions 331 as well as the position where the protrusions 331 are disposed in the rail assembly 330. In another embodiment that is not shown, the protrusions may also be disposed on the base plate 134 of the second rail L2. Moreover, in another embodiment that is not shown, the protrusions 331 having an arc-shaped column-like structure as described in the embodiment may be changed into a rough structure formed on the surface of the spiral plate 132b or the base plate 134 to reduce the speed of the ball 20.

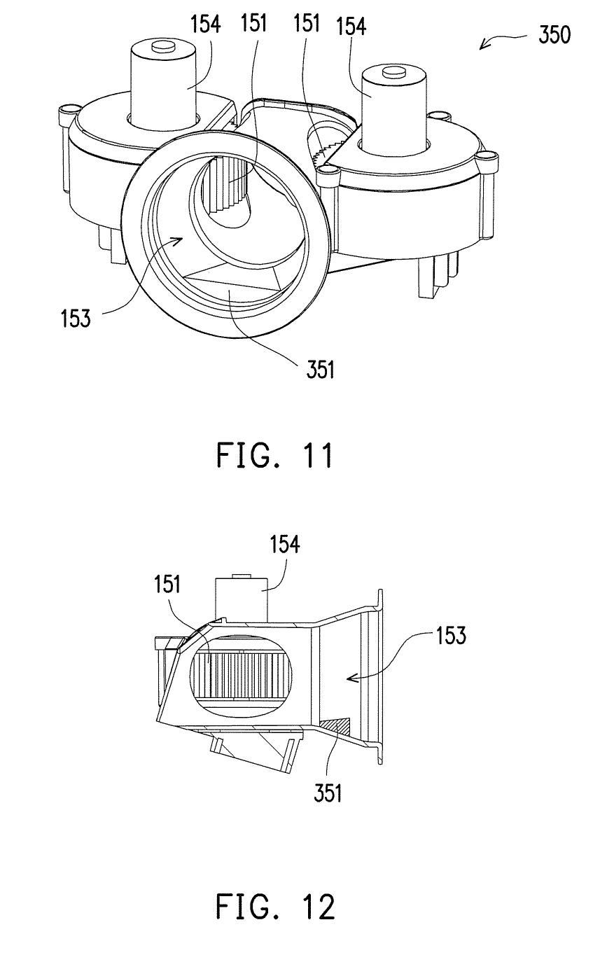

FIG. 11 is a schematic view illustrating partial components of a ball serving mechanism for pet according to another embodiment of the invention, describing related features of a launch module 350. FIG. 12 is a partial sectional view illustrating the launch module according to FIG. 11. Please refer to FIGS. 11-12. Different from the above embodiment, the launch module 350 is provided with a bump 351 disposed in a lower inner wall of the launch tube 153 and substantially located between the outlet E2 (shown by the above embodiment) and the ball serving rollers 151. With such configuration, after the ball 20 (shown by FIG. 1) is driven by the ball serving rollers 151, the ball 20 can be launched out of the ball serving mechanism for pet in a casting manner upward direction (i.e. toward the positive Z-axis direction). The invention provides no limitation to the appearance and size of the bump 351. In another embodiment that is not shown, the rising height and the angle that the bump facing upward in the launch tube may be designed corresponding to the user's need so the launched ball can move along different traces. Meanwhile, it should be pointed out that all the embodiments described above may be combined and adopted in different ways depending on needs.

As indicated above, in the embodiments of the invention, with the cooperation of the rail assembly and the launch module of the ball serving mechanism for pet, the ball enters the housing via the inlet and moves along the first rail that surrounds an axis in the rail assembly through the second rail connected to the first rail to arrive the launch module. Thereafter, the ball is launched out of the housing from the outlet by being driven by the launch module. Accordingly, the training process of training the pet to “catch object” may be provided. In the meantime, after the pet puts the ball back to the ball serving mechanism for pet, the above process can be repeated.

Moreover, since the first rail is a structure formed in a spiral surrounding manner inside the housing instead of a structure that let the ball enter the housing and move directly to the launch module, there is sufficient time for the ball serving rollers of the invention to be activated from the still status to rotate to the launch speed. On the other hand, if the first rail is not provided, the ball that enters from the inlet will immediately go to the ball serving rollers. However, at that point, there is not enough time for the ball serving rollers to be activated and speed up, in that case, the ball may be stocked in the ball serving rollers and may even interrupt or interfere the ball serving rollers from rotating.

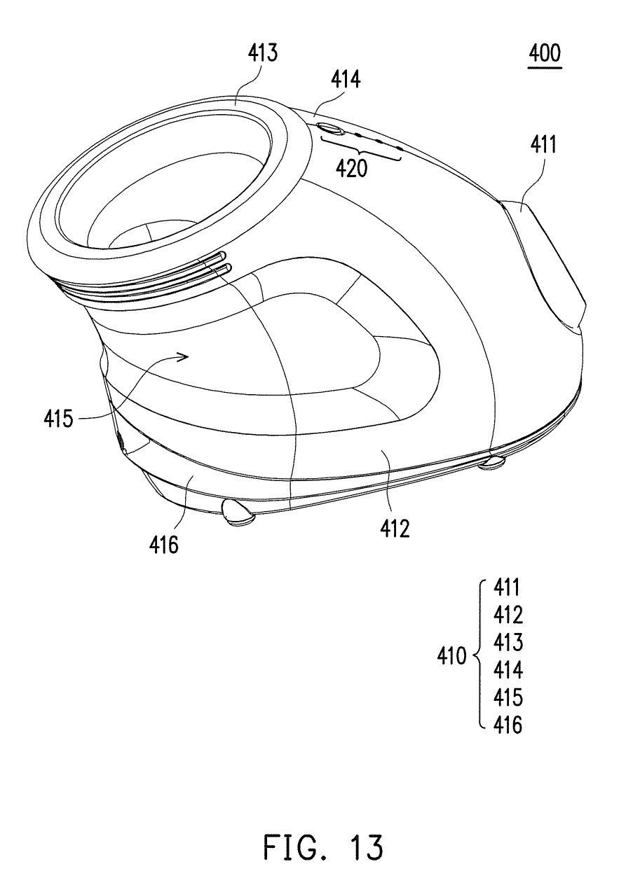

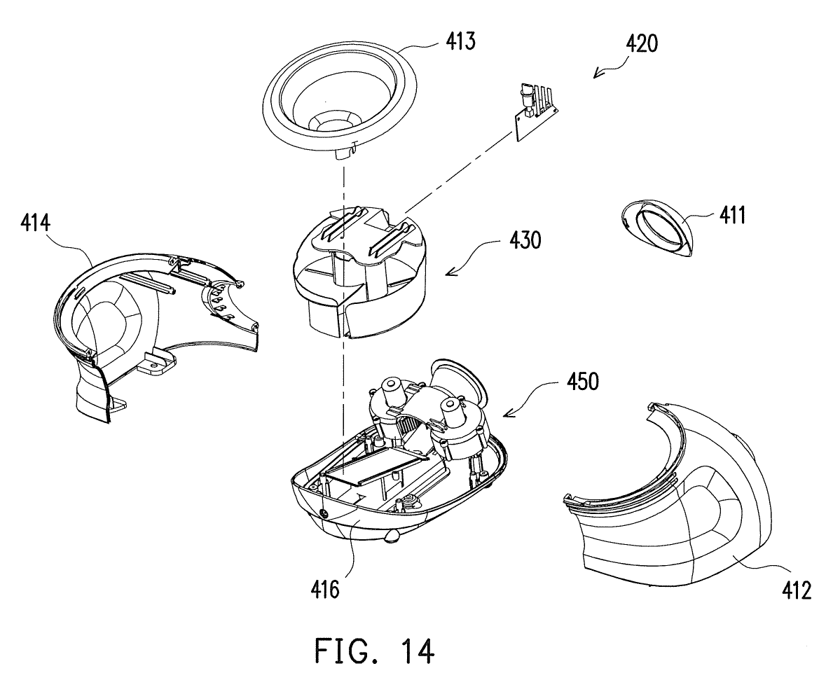

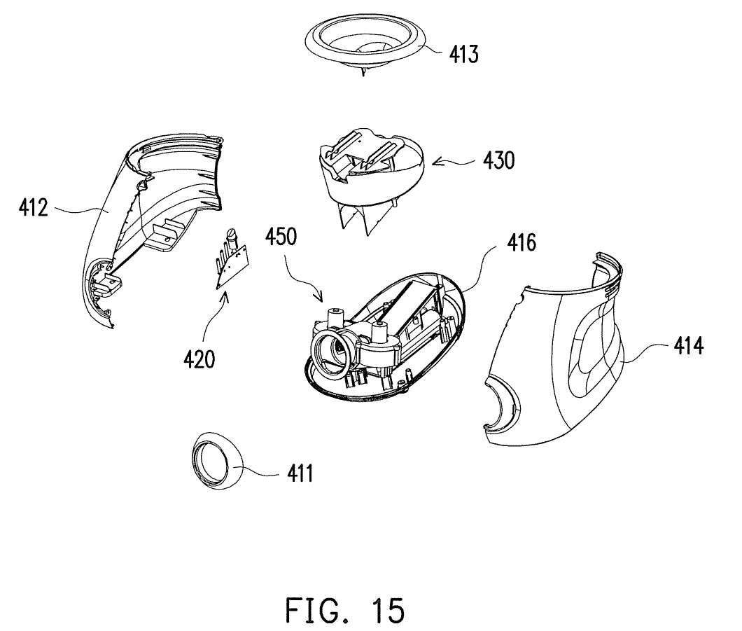

FIG. 13 is a schematic perspective view illustrating a ball serving mechanism for pet according to another embodiment of the invention. FIGS. 14 and 15 are exploded views illustrating the ball serving mechanism for pet in FIG. 13. Please refer to FIGS. 13-15, in the embodiment, a ball serving mechanism for pet 400 is similar to the embodiment above, and includes a housing 410, a display assembly 420, a rail assembly 430, a launch module 450, wherein the sensor unit 140 and control unit 160 in the embodiment are the same as embodiments above and omitted here. Besides, the rail assembly 430 is similar to the embodiment shown in FIG. 9 that a barrier structure stands at the edge of the spiral plate and along therewith.

In the embodiment, the housing 410 consists of a base 416, a first housing 412, a second housing 414, an upper cover 413 and a front cover 411 which are similar to the embodiment shown in FIGS. 3 and 4. Besides, the first housing 412 and the second housing 414 further has a half-recess structure respectively, and a recess 415 is formed after the first housing 412 being assembled to the second housing 414.

Therefore, in the invention, the ball serving mechanism for pet not only provides the training process for training the pet to “catch object”, but also can repeats the training process after the pet puts the ball back to the ball serving mechanism for pet. Accordingly, after the pet is familiar with the repeated “object catching” process, there is no need for the pet owner to stay with the pet and the ball serving mechanism, whereby effectively saving the owner's energy and time. In the meantime, with cooperation of the inner structure (e.g. rail) and related components (e.g. launch module), the ball serving mechanism for pet can operate smoothly without problems.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A ball serving mechanism for pet, comprising:
a housing having an inlet and an outlet;
a rail assembly disposed within the housing and connected to the inlet, and
a launch module disposed within the housing and connected between the rail assembly and the outlet, a ball being suitable for entering the rail assembly via the inlet and continuously moving in the rail assembly via gravity to the launch module, after being driven by the launch module, the ball being launched out of the housing via the outlet.

2. The ball serving mechanism for pet according to claim 1, wherein the rail assembly is in a spiral shape.

3. The ball serving mechanism for pet according to claim 1, wherein the rail assembly comprises a first rail and a second rail, the first rail is connected to the inlet, the second rail is connected between the first rail and the launch module, the first rail surrounds an axis, and the axis is parallel with a normal of a plane on which the housing is placed.

4. The ball serving mechanism for pet according to claim 3, wherein the housing comprises a base, and the rail assembly comprises:
a base plate assembled on the base;
a frame assembled on the base and jointed with the base late, the base plate and a portion of the frame forming the second rail; and
a cover assembled on the base and covering the base plate and the frame, another portion of the frame and the cover forming the first rail.

5. The ball serving mechanism for pet according to claim 3, wherein the housing comprises a base, and the rail assembly comprises:
a base plate assembled on the base;
a frame assembled on the base and jointed with the base plate, the base plate and a portion of the frame forming the second rail; and
a barrier forming on an external edge of the frame, another portion of the frame and the barrier forming the first rail.

6. The ball serving mechanism for pet according to claim 1, wherein the housing further comprises:
a base;
a first housing; and
a second housing, and the first housing and the second housing being bilaterally symmetrically assembled on the base.

7. The ball serving mechanism for pet according to claim 1, wherein the housing comprises a base, and the launch module comprises:
a launch tube disposed on the base and connected between the rail assembly and the outlet; and
a pair of ball serving rollers disposed at opposite sides of the launch tube, a portion of each of the ball serving rollers passing through a tube wall of the launch tube and protruding in the launch tube.

8. The ball serving mechanism for pet according to claim 7, further comprising:
at least a motor disposed within the housing and connected to the ball serving rollers, the motor driving the pair of ball serving rollers to rotate:
a controlling unit disposed within the housing and electrically connected to the motor; and
a sensor unit disposed on the inlet and electrically connected to the controlling unit, wherein when the ball enters the rail assembly via the inlet, the sensor unit senses the ball and transmits a signal to the controlling unit such that the controlling unit activates the motor to drive the pair of ball serving rollers.

9. The ball serving mechanism for pet according to claim 8, wherein the ball moves to the pair of ball serving rollers from the inlet within a first time period, and the motor drives the pair of ball serving rollers to rotate to a launch speed from a still status within a second time period, the second time period is less than or equivalent to the first time period.

10. The ball serving mechanism for pet according to claim 3, wherein at least one of the first rail and the second rail has at least a protrusion disposed on a surface thereof for reducing a moving speed of the ball in the rail assembly.
